(19) United States
(12) Patent Application Publication
(10) Pub. No.: US 2004/0092649 A1
(43) Pub. Date: May 13, 2004

(54) Method for producing stable, colorless butadiene rubbers

(76) Inventors: Heinz-Dieter Brandt, Willich (DE); Martina Brandt, Willich (DE); Franziska Hanne Brandt, Willich (DE); Inken Margarethe Brandt, Willich (DE); Rolf Peter, Dormagen (DE); Bernd Stollfuss, Gladbach (DE)

Correspondence Address: BAYER POLYMERS LLC, 100 BAYER ROAD, PITTSBURGH, PA, 15205, US

(21) Appl. No.: 10/297,293

(22) PCT Filed: May 25, 2001
(86) PCT No.: PCT/EP01/05971

(30) Foreign Application Priority Data
Jun. 6, 2000 (DE) 100 27 891.4

(51) Int. Cl. C08L 61/04

(52) U.S. Cl. 524/511

(57) ABSTRACT

Stable, colourless diene rubbers stabilised with phenolic compounds are produced by adding one or more phenolic compounds (stabilisers) to the polymer blend in a subsequent process step after polymerisation of the monomers used and adjusting the pH value and oxygen content such that the polymer blend displays a pH value in the range from 4 to 11 and the oxygen content is 0 to 0.3 ppm, relative to the water content of the polymer blend.

Polymerisation methods for producing butadiene rubbers, such as lithium polybutadiene (Li—BR), cobalt polybutadiene (Co—BR), neodymium polybutadiene (Nd—BR), nickel polybutadiene (Ni—BR), titanium polybutadiene (Ti—BR), styrene-butadiene block copolymers (SB, SBS, SEBS), random styrene-butadiene copolymers (L-SBR), butadiene-isoprene copolymers (BI), styrene-butadiene-isoprene terpolymers (SIB), are known and described, for example, in Houben-Weyl, Volume E20, page 798 et seq., Becker/Braun, Kunststoffhandbuch, 4, Polystyrol, p. 145 to 164, or in Ullmann's Encyclopedia, Vol. A23, Rubber, 3. Synthetic, p. 269 to 282.

The protection of butadiene rubbers produced by the known polymerisation methods against a change in the polymer structure during processing or storage by the addition of stabilisers, e.g. antioxidants, after polymerisation is also known. Examples of known stabilisers for butadiene rubbers include p-phenylene diamine derivatives, phenyl phosphites or phenolic antioxidants. Reference is made in this connection to D. J. Burlett, Paper 98, ACS Meeting, May 5-8, 1998 or E. Földes, J. Lohmeijer, J. of Appl. Polym. Sc. 65, 4 (1997), 761-775.

The use of such stabilisers is sometimes associated with serious problems, however. p-Phenylene diamine derivatives, for example, cause a severe discolouration of the rubbers. Phenyl phosphites hydrolyse during processing of the rubbers, releasing substituted phenols, which cause environmental concerns since they can display oestrogen-like effects. Furthermore, the stabalising action of the phenolic antioxidants used is not always sufficient to obtain stable, colourless butadiene rubbers.

The addition of special phenolic compounds, such as phenolic thioethers, e.g. Irganox® 1520 from Ciba Geigy (see EP-A 428 973), to the butadiene rubbers as stabilisers is also known. It has been proven in practice, however, that considerable technical effort is nevertheless required in order to produce light-coloured, stable butadiene rubbers with their aid. The production of light-coloured butadiene rubbers by addition of epoxidised soya bean oil and organic acids whilst maintaining a certain pH value is also known (see WO 98/29457). The method therein described is complicated to perform, however. Moreover, additives are used that remain in the product and cause problems during the further course of the process or during subsequent use, in the impact modification of styrene polymers, for example. Furthermore, the discolouration of diene rubbers cannot be completely suppressed even by the method described in WO 98/29457.

The object of the present invention is now to provide a method that leads by technically simple means to stable, colourless diene rubbers stabilised with phenolic compounds.

The invention therefore provides a method for the production of stable, colourless diene rubbers stabilised with phenolic compounds, characterised in that after polymerisation of the monomers used, phenolic compounds (stabilisers) are added to the polymer blend in a subsequent process step and the pH value and oxygen content are adjusted such that the polymer blend displays a pH value in the range from 4 to 11 and the oxygen content is 0 to 0.3 ppm, relative to the water content of the polymer blend.

The pH value in the polymer blend preferably displays a range from 5 to 10, most particularly preferably a range from 7 to 9.

The oxygen content in the polymer blend is preferably 0 to 0.2 ppm, most particularly preferably 0 to 0.1 ppm, determined by means of a Winkler titration (Aquamerk 1.11107.001).

Suitable monomers for production of the diene rubbers according to the invention include all dienes known- for such purposes, for example 1,3-butadiene, isoprene and/or dimethyl butadiene, preferably 1,3-butadiene and/or isoprenes, particularly 1,3-butadiene.

In addition to the dienes used, further unsaturated compounds that can be polymerised with these, such as vinyl group-containing compounds, can be used. Examples include styrene, α-methyl styrene, vinyl toluene and/or tert-butyl styrene, preferably styrene and/or α-methyl styrene, particularly styrene.

It is further possible to add other known unsaturated compounds, such as (meth)acrylates, preferably methyl (meth)acrylate and/or tert-butyl (meth)acrylate, to the structural components for the butadiene rubbers according to the invention.

Using these structural components it is possible to produce the copolymers and terpolymers described in the introduction with the conventional quantity ranges of structural components. Thus the above-mentioned other unsaturated compounds that can be copolymerised with the dienes can be used in quantities of up to 50 wt. %.

The polymerisation according to the invention of the monomers described can be performed by conventional means, for example in the presence of lithium, cobalt, neodymium, nickel or titanium compounds as catalysts, whereby anionic polymerisation in the presence of an inert, organic solvent, such as hexane, cyclohexane, pentane and/or toluene, is preferred. The known solvents can of course be used alone or in combination with one another.

The polymerisation is conventionally performed at temperatures in the range form 50° C. to 150° C. The conditions for such a polymerisation are known and are described for example in the publications cited in the introduction.

It is important for the method according to the invention that after polymerisation, phenolic stabilisers are added to the polymer blend or polymer solution in a subsequent process step and that the pH value and oxygen content are adjusted to the above-mentioned ranges.

In practice, for example, polymerisation of butadiene rubbers is shortstopped by addition of a compound having an acid hydrogen atom. Owing to the nature of the process it is therefore convenient to add one or more phenolic compounds to the polymer solution as stabilisers and to adjust the pH value and the oxygen content of the polymer blend or solution to the above-mentioned ranges at the same time as the polymerisation is shortstopped.

Polymerisation can be shortstopped by conventional means by the addition of water, alcohols, organic or inorganic acids and/or phenols. The polymerisation according to the invention is preferably shortstopped with water.

After the phenolic stabilisers have been added to the polymer blend and the oxygen content and pH value adjusted, further process steps can optionally be added, such as washing steps. The solvent can then be removed by coagulating the rubber and stripping with steam. Direct processing can naturally also be performed, whereby the volatile components are removed by evaporation in suitable equipment such as stripping extruders, drum dryers, list units, for example. In the case of processing by coagulation and stripping, the water is removed in appropriate equipment such as expellers, expanders or tunnel dryers.

Examples of phenolic stabilisers that can be added to the polymer blend alone or in combination with one another include:

Alkylated monophenols, e.g. 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-i-butylphenol, 2,6-di-cyclopentyl-4-methylphenol, 2-(α-methylcyclohexyl)-4,6-dimethylphenol, 2,6-di-octadecyl-4-methylphenol, 2,4,6-tricyclohexylphenol, 2,6-di-tert-butyl-4-methoxymethylphenol;

Alkylated hydroquinones, e.g. 2,6-di-tert-butyl-4-methoxyphenol, 2,5-di-tert-butyl hydroquinone, 2,5-di-tert-amyl hydroquinone, 2,6-diphenyl-4-octadecyloxyphenyl;

Hydroxylated thiodiphenyl ethers, e.g. 2,2′-thio-bis(6-tert-butyl-4-methylphenol), 2,2′-thio-bis(4-octylphenol), 4,4′-thio-bis(6-tert-butyl-3-methylphenol), 4,4′-thio-bis(6-tert-butyl-2-methylphenol);

Alkylidene bisphenols, e.g. 2,2′-methylene-bis(6-tert-butyl-4-methylphenol), 2,2′-methylene-bis(6-tert-butyl-4-ethylphenol), 2,2′-methylene-bis(4-methyl-6(α-methylcyclohexyl) phenol, 2,2′-methylene-bis(4-methyl-6-cyclohexylphenol), 2,2′-methylene-bis(6-nonyl-4-methylphenol), 2,2′-methylene-bis-(4,6-di-tert-butylphenol), 2,2′-ethylidene-bis(4,6-di-tert-butylphenol), 2,2′-ethylidene-bis(6-tert-butyl-4-isobutylphenol), 2,2′-ethylidene-bis(6-tert-butyl-4-isobutylphenol), 2,2′-methylene-bis[6-(α-methylbenzyl)-4-nonylphenol), 2,2′-methylene-bis-[6-(α,α-dimethylbenzyl)-4-nonylphenol], 4,4′-methylene-bis(2,6-di-tert-butylphenol), 4,4′-methylene-bis(6-tert-butyl-2-methylphenol), 1,1-bis(5-tert-butyl-4-hydroxy-2-methylphenyl) butane, 2,6-di(3-tert-butyl-5-methyl-2-hydroxybenzyl)-4-methylphenol, 1,1,3-tris(5-tert-butyl-4-hydroxy-2-methylphenyl) butane, 1,1-bis(5-tert-butyl-4-hydroxy-2-methylphenyl)-3-n-dodecylmercaptobutane, ethylene glycol-bis[3,3-bis(3′-tert-butyl-4′-hydroxyphenyl) butyrate], di(3-tert-butyl-4-hydroxy-5-methylphenyl) dicyclopentadiene, di[2-(3′-tert-butyl-2′-hydroxy-5′-methylbenzyl-6tert-butyl-4-methylphenyl] terephthalate;

Benzyl compounds, e.g. 1,3,5-tri(3,5-di-tert-butyl-4-hydroxybenzyl)-2,4,6-trimethylbenzene, di(3,5-di-tert-butyl-4-hydroxybenzyl) sulfide, 3,5-di-tert-butyl-4-hydroxybenzyl isooctyl mercaptoacetate, bis(4-tert-butyl-3-hydroxy-2,6-dimethylbenzyl) dithiol terephthalate, 1,3,5-tris(3,5-di-tert-butyl-4-hydroxybenzyl) isocyanurate, 1,3,5-tris(4-tert-butyl-3-hydroxy-2,6-dimethylbenzyl) isocyanurate, 3,5-di-tert-butyl-4-hydroxylbenzyl dioctadecyl phosphonate, 3,5-di-tert-butyl-4-hydroxybenzyl monoethyl phosphonate, calcium salt;

Acylaminophenols, e.g. 4-hydroxylauric acid anilide, 4-hydroxystearic acid anilide, 2,4-bis-octylmercapto-6-(3,5-di-tert-butyl-4-hydroxyanilino)-s-triazine, N-3,5-di-tert-butyl-4-hydroxyphenyl) acetyl carbamate;

Esters of β-(3,5-di-tert-butyl-4-hydroxyphenol) propanoic acid with monohydric or polyhydric alcohols, such as e.g. methanol, octadecanol, 1,6-hexanediol, neopentyl glycol, thiodiethylene glycol, diethylene glycol, triethylene glycol, pentaerythritol, tris-hydroxyethyl isocyanurate, dihydroxyethyl oxalic acid diamide;

Esters of β-(5-tert-butyl-4-hydroxy-3-methylphenyl) propanoic acid with monohydric or polyhydric alcohols, such as e.g. methanol, octadecanol, 1,6-hexanediol, neopentyl glycol, thiodiethylene glycol, diethylene glycol, triethylene glycol, pentaerythritol, tris-hydroxyethyl isocyanurate, dihydroxyethyl oxalic acid diamide;

Phenolic thioethers, e.g. 2,4-bis(n-octylthiomethyl)-6-methylphenol, 2,4-bis(tert-octylthiomethyl)-6-methylphenol, 2,4-bis(tert-dodecylthiomethyl)-6-methylphenol, 2,4-bis(n-octylthiomethyl)-3,6-dimethylphenol, 2,4-bis(n-octylthiomethyl)-6-tert-butylphenol, 2,4-bis(n-dodecylthiomethyl)-6-tert-butyl-phenol, 2,4-bis(n-octylthiomethyl)-6-tert-butyl-3-methylphenol and 2,4-bis(n-dodecylthiomethyl)-6-tert-butyl-3-methylphenol.

2,6-di-tert-butyl-4-methylphenol, 2,5-di-tert-butyl hydroquinone, 2,2′-methylene-bis(6-tert-butyl-4-methylphenol), 2,2′-methylene-bis(4-methyl-6-(α-methylcyclohexyl) phenol, 2,2′-methylene-bis(4,6-di-tert-butylphenol), 2,4-bis-octylmercapto-6-(3,5-di-tert-butyl-4-hydroxyanilino)-s-triazine, triethylene glycol, octadecanol, 1,6-hexanediol, neopentyl glycol, thiodiethylene glycol, pentaerythritol, 2,4-bis(n-octylthiomethyl)-6-methylphenol are preferred. 2,6-di-tert-butyl-4-methylphenol, octadecanol, neopentyl glycol, pentaerythritol, 2,4-bis(n-octylthiomethyl)-6-methylphenol are particularly preferred.

The stabilisers are known and are described for example in brochures from known stabiliser manufacturers, for example Ciba Specialities, Great Lakes, Goodyear, Flexis, General Electric, Sumitomo.

The quantity of stabilisers to be added depends inter alia on the dienes used and is also governed by the subsequent use of the diene rubbers. Quantities in the range from 0.03 to 0.5 wt. %, preferably 0.05 to 0.25 wt. %, relative to solid rubber, are conventionally used.

If the stabilisers are used in combination with one another, the most favourable mixing ratio in each case can easily be determined by means of appropriate preliminary tests and is governed inter alia, as has already been described, by the subsequent application of the rubbers and by the dienes used.

A wide variety of methods can be used to adjust and check the oxygen content in the polymer blend; the oxygen content can for example be adjusted or checked by means of an appropriate reduction of the oxygen content in the shortstop reagents, e.g. in the water. The known methods of oxygen reduction are suitable for this purpose, such as evacuation and/or passing through of inert gases (e.g. N₂, argon) and/or distillation and/or stripping the oxygen by means of hot steam.

It is further possible to adjust the oxygen content within the specified range by addition of reducing agents. These can be of both an organic and an inorganic nature. Inorganic sulfur compounds, such as sulfites, thiosulfates and/or dithionites are particularly suitable. Especially suitable examples are the alkali and alkaline-earth salts of the cited sulfur compound. Sodium dithionite or sodium thiosulfate is preferably used.

In order to adjust the oxygen content according to the invention, the cited reducing agents are used in quantities of approx. 0.0001 to 1 phr, relative to the solid rubber present, preferably 0.001 to 0.5 phr, particularly preferably in quantities of 0.01 to 0.2 phr.

It is likewise important for the method according to the invention that the pH value of the polymer blend is within a certain range in order to avoid undesirable secondary reactions. All acids and bases, which are added to the polymer blend, are suitable in principle for adjusting the pH range as previously described. For example, aqueous solutions of caustic soda and caustic potash, sulfuric acid, phosphoric acid, phosphorous acid, citric acid, carbon dioxide, hydrochloric acid, boric acid, stearic acid and/or potassium hydrogen-phthalate can be used.

Caustic soda, sulfuric acid, citric acid and/or boric acid are preferably used.

The quantity of acids or bases is then metered such that the desired pH value is established in the polymer blend.

It should be mentioned that the oxygen content and the pH value are governed in particular by the type of monomers used, the type of phenolic stabilisers used and by the subsequent application of the diene rubbers and are adjusted accordingly. The most favourable ranges can likewise easily be determined by means of appropriate preliminary tests.

The stable, colourless diene rubbers stabilised with phenolic compounds and produced according to the invention can be used for the manufacture of vulcanisates of all types, for example for the manufacture of tyres, hoses or seals, and for the impact modification particularly of polymers based on vinyl-aromatic compounds, such as polystyrene, and of ABS polymers produced by the bulk process. Particularly suitable for this purpose is the polybutadiene produced according to the invention and polymerised by means of lithium-organic compounds (Li—BR).

### EXAMPLES

### Performing the Tests

The butadiene polymers were produced using the conventional techniques of anionically initiated solution polymerisation. All starting materials were purified in accordance with the particular requirements.

| | |
|---|---|
| 1,3-butadiene: | destabilised and distilled under N₂ |
| technical hexane: | from Exxon. Distilled azeotropically under N₂ |
| n-butyl lithium: | commercial 23% solution in n-hexane from Chemetall, |
| | Innerstetal 2, Postfach 1180, 38685 Langelsheim |

150 g 1,3-butadiene dissolved in 1290 g technical hexane were polymerised in each case for 1.5 h at 90° C. after addition of 1.5 mmol n-butyl lithium. The rubber solution was then discharged via a transfer pipe into a second reactor containing 30 phr water adjusted to pH 8.7 with NaOH, the-stabiliser (0.2 phr) and the reducing agent at 80° C. The reactor was then stirred for 24 hours at 80° C. The volatile components were then removed in a vacuum drying cabinet at 50° C. over 24 hours. The resulting product was visually assessed for discolouration.

### Irganox® Products from Ciba Specialities Used

Irganox® 1520 LR (contains epoxidised soya bean oil)

Irganox® 1520 L

### Grades of Water Used

Water was used in various grades:

A) N₂ passed through for 1 hour before use (O₂ content: 0.8 ppm)

B) No pretreatment (O₂ content: 1.8 ppm)

C) Evacuated 5 times under an N₂ atmosphere (O₂ content: <0.1 ppm)

D) Air passed through for 2 h before use (O₂ content: 7 ppm)

If reducing agents such as sodium dithionite, sodium thiosulfate, sodium sulfite are added, O₂ can no longer be detected in the water.

| Comparative test A | |
|---|---|
| Stabiliser: | Irganox ® 1520 L |
| Water grade: | A) |
| Additive: | Versatic acid (6 wt. % relative to |
| | stabiliser) |
| Comparative test B | |
| Stabiliser: | Irganox ® 1520 LR |
| Water grade: | A) |
| Additive: | Versatic acid (6 wt. % relative to |
| | stabiliser) |
| Comparative test C | |
| Stabiliser: | Irganox ® 1520 L |
| Water grade: | A) |
| Comparative test D | |
| Stabiliser: | Irganox ® 1520 LR |
| Water grade: | A) |
| Comparative test E | |
| Stabiliser: | Irganox ® 1520 L |
| Water grade: | A) |
| Additive: | Versatic acid (3 mmol) |
| Comparative test F | |
| Stabiliser: | Irganox ® 1520 L |
| Water grade: | A) |
| Additive: | Citric acid (0.1 mmol) |
| Comparative test G | |
| Stabiliser: | Irganox ® 1520 L |
| Water grade: | A) |
| Additive: | Versatic acid (6 wt. % relative to |
| | stabiliser), citric acid (0.1 mmol) |
| Comparative test H | |
| Stabiliser: | Irganox ® 1520 L |
| Water grade: | B) |
| Comparative test I | |
| Stabiliser: | Irganox ® 1520 L |
| Water grade: | D) |
| Example 1 (according to the invention) | |
| Stabiliser: | Irganox ® 1520 L |
| Water grade: | A) |
| Additive: | Sodium dithionite (0.1 phr) |
| Example 2 (according to the invention) | |
| Stabiliser: | Irganox ® 1520 L |
| Water grade: | B) |
| Additive: | Sodium dithionite (0.1 phr) |
| Example 3 (according to the invention) | |
| Stabiliser: | Irganox ® 1520 L |
| Water grade: | C) |
| Additive: | — |
| Example 4 (according to the invention) | |
| Stabiliser: | Irganox ® 1520 L |
| Water grade: | A) |
| Additive: | (0.1 phr) sodium thiosulfate |
| Example 5 (according to the invention) | |
| Stabiliser: | Irganox ® 1520 L |
| Water grade: | A) |
| Additive: | (0.05 phr) sodium dithionite |

### Assessment of the Colour

The colour of the BR rubber was assessed visually as follows:

| | Comparison | Comparison | Comparison | Comparison |
|---|---|---|---|---|
| | A | B | C | D |
| Colour | yellow | yellowish | yellowish | yellowish |
| | Comparison | Comparison | Comparison | Comparison |
| | E | F | G | H |
| Colour | yellow | yellowish | yellow | intensely |
| | | | | yellow |
| | Comparison | | | |
| | I | | | |
| Colour | brown | | | |
| According to | Example | Example | Example | Example |
| the invention | 1 | 2 | 3 | 4 |
| Colour | colourless | colourless | colourless | colourless |
| According to | Example | | | |
| the invention | 5 | | | |
| Colour | colourless | | | |

### Assessment of Stability

All of the rubbers produced were soluble and displayed no indication of the onset of crosslinking.

1. Method for the production of stable, colourless diene rubbers stabilised with phenolic compounds, characterised in that after polymerisation of the monomers used, phenolic compounds (stabilisers) are added to the polymer blend in a subsequent process step and the pH value and oxygen content are adjusted such that the polymer blend displays a pH value in the range from 4 to 11 and the oxygen content is 0 to 0.3 ppm, relative to the water content of the polymer blend.

2. Use of the diene rubbers obtainable according to claim 1 for the manufacture of vulcanisates of all types and for the impact modification of polymers based on vinyl-aromatic compounds.
